(19) United States
(12) Patent Application Publication
(10) Pub. No.: US 2009/0082543 A1
(43) Pub. Date: Mar. 26, 2009

(54) METHOD OF PREPARING POLY(AMIC ACID) AND METHOD OF PREPARING POLYIMIDE

(75) Inventors: Mitsuru UEDA, Meguro-ku (JP); Tomohito Ogura, Meguro-ku (JP); Shinya Nishimura, Sakura-shi (JP)

Correspondence Address: SUGHRUE MION, PLLC, 2100 PENNSYLVANIA AVENUE, N.W., SUITE 800, WASHINGTON, DC, 20037, US

(73) Assignees: Tokyo Institute of Technology, Tokyo (JP); Fujikura Ltd., Tokyo (JP)

(21) Appl. No.: 12/268,759

(22) Filed: Nov. 11, 2008

Related U.S. Application Data
(63) Continuation of application No. PCT/JP2007/059892, filed on May 14, 2007.

(30) Foreign Application Priority Data
May 12, 2006 (JP) 2006-134403

(51) Int. Cl. C08G 69/28

(52) U.S. Cl. 528/353

(57) ABSTRACT

A method of preparing a poly(amic acid) includes a step of reacting an aromatic diacid anhydride or alicyclic diacid anhydride, an aliphatic diamine or alicyclic diamine, and an acid having a pKa of 3 to 5. A method of preparing a polyimide by imidating the resulting poly(amic acid) is also disclosed.

### CROSS REFERENCE TO RELATED APPLICATIONS

This is a continuation of Application PCT/JP2007/059892, filed May 14, 2007. The application claims priority from Japanese Patent Application No. 2006-134403 filed on May 12, 2006, the entire contents of which are incorporated herein by reference.

### TECHNICAL FIELD

The present invention relates to a method of preparing a poly(amic acid) and a method of preparing a polyimide.

### BACKGROUND

In general, polyimide is obtained by subjecting tetracarboxylic acid dianhydride and a diamine compound to a polycondensation reaction to obtain a poly(amic acid), and further subjecting the product to an imidation reaction. Polyimide is a polymeric material which has very high thermal stability, and is useful as, for example, an electrically insulating material, a heat-resistant coating film material, or a high performance printed circuit board material.

In particular, polyimides obtained using a tetracarboxylic acid anhydride, such as aromatic diacid anhydrides or alicyclic diacid anhydrides, and a diamine compound, such as aliphatic diamines or alicyclic diamines, are expected to have excellent properties such as a low dielectric constant, high transparency, and high heat resistance. Among these, examples of alicyclic polyimides which are obtained by using alicyclic diacid anhydrides are disclosed in, for example, Patent Documents 1 or 2.
[Patent Document 1] JP-A No. 2002-316990
[Patent Document 2] JP-A No. 2002-256074

### SUMMARY

However, it was very difficult to synthesize polyamide using aliphatic diamines or alicyclic diamines. The reasons are conceived to be as follows.

In the reaction between an aromatic diacid anhydride and an aromatic diamine, nucleophilicity of the aromatic diamine is maintained favorably because the pKa values of both the aromatic diacid anhydride and the aromatic diamine are from 3 to 5, and therefore the two compounds can be copolymerized to synthesize a poly(amic acid). Furthermore, the poly(amic acid) product can be dehydrated and cyclized by heating, and then subjected to an imidation reaction, resulting in the synthesis of a high molecular weight polyimide.

However, in the reaction between an aromatic diacid anhydride or alicyclic diacid anhydride (formula 1), and an aliphatic diamine or alicyclic diamine (formula 2), since both of the pKa values of the raw material aliphatic diamine and alicyclic diamine (formula 2) are approximately 11 with strong basicity, the ionic bonding ability becomes stronger, and the nucleophilicity of the aliphatic diamine or alicyclic diamine (formula 2) becomes weaker. For this reason, the associated reaction generates heat and rapidly forms an amide acid salt (formula 3), and the resulting salt becomes insoluble in the solvent and precipitates out. Therefore, synthesis of a high molecular weight poly(amic acid) (formula 4) was difficult, and as a result, synthesis of a high molecular weight polyimide (formula 5) was also difficult.

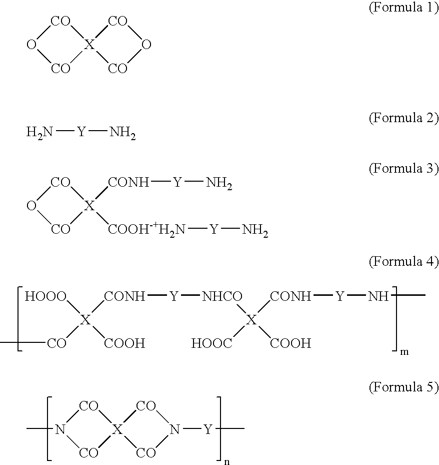

Under the circumstances as described above, it is an object of the present invention to provide a method of preparing a poly(amic acid), by which an aromatic diacid anhydride or an alicyclic diacid anhydride, and an aliphatic diamine or an alicyclic diamine can be copolymerized to a high molecular weight polymer within a short time; and a method of preparing a polyimide.

From the results of careful studies the present inventors found that a poly(amic acid) (formula 4) can be prepared by carrying out copolymerization to a high molecular weight polymer within a short time even if using an aromatic diacid anhydride or alicyclic diacid anhydride, and an aliphatic diamine or alicyclic diamine as reactants, which are considered to be difficult to carry out the copolymerization. The present inventors also found that a high molecular weight polyimide (formula 5) could be prepared by imidating the poly(amic acid).

That is, the present invention relates to a method of preparing a poly(amic acid), including a step of allowing an aromatic diacid anhydride or alicyclic diacid anhydride, an aliphatic diamine or alicyclic diamine, and an acid having a pKa of 3 to 5 to react.

Further, in the present invention, a step of subjecting an aliphatic diamine or alicyclic diamine to an acid having a pKa of 3 to 5, and then reacting the resultant with an aromatic diacid anhydride or alicyclic diacid anhydride, may be used.

In the present invention, the acid having a pKa of 3 to 5 may be an acid having a low molecular weight.

In the present invention, the acid having a pKa of 3 to 5 may be an organic acid.

The present invention also relates to a method of preparing polyimide including a step of imidating a poly(amic acid) obtained by the method according to the present invention.

According to the exemplary embodiments of the present invention, an aromatic diacid anhydride or alicyclic diacid anhydride, and an aliphatic diamine or alicyclic diamine can be copolymerized to a high molecular weight polymer within a short time, and a high molecular weight poly(amic acid) and a polyimide can be prepared.

### DETAILED DESCRIPTION OF EXEMPLARY EMBODIMENTS OF THE INVENTION

The diacid anhydride used in the production method of the invention is an aromatic diacid anhydride or an alicyclic diacid anhydride (formula 1). An aromatic diacid anhydride or alicyclic diacid anhydride having a pKa of 3 to 5 can be suitably used.

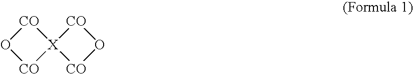

As the aromatic diacid anhydride, there may be mentioned compounds represented by above formula 1 in which X represents the following formulae 6 to 8.

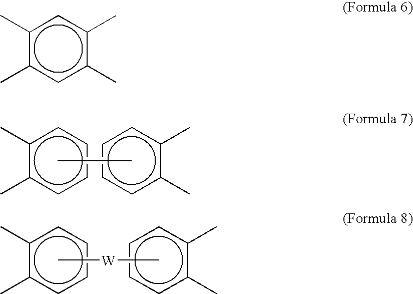

For example, pyromellitic dianhydride, 3,3′,4,4′-biphenyltetracarboxylic dianhydride, 2,3,3′,4′-biphenyltetracarboxylic dianhydride, 3,3′,4,4′-benzophenonetetracarboxylic dianhydride, 3,3′,4,4′-diphenyl ether tetracarboxylic dianhydride, 3,3′,4,4′-diphenylmethanetetracarboxylic dianhydride, 2,2-bis(3,4-dicarboxyphenyl)propane dianhydride, 2,2-bis(3,4-dicarboxyphenyl)hexafluoropropane dianhydride, 3,3′,4,4′-diphenylsulfonetetracarboxylic dianhydride, 2,2-bis[4-(3,4-dicarboxyphenoxy)phenyl]propane dianhydride, 4,4′-bis(3,4-dicarboxyphenoxy)diphenyl ether dianhydride, 4,4′-bis(3,4-dicarboxyphenoxy)diphenyl sulfide dianhydride, 4,4′-bis(3,4-dicarboxyphenoxy)benzophenone dianhydride, 4,4′-bis(3,4-dicarboxyphenoxy)diphenylsulfone dianhydride, 2,2-bis[4-(2,3-dicarboxyphenoxy)phenyl]propane dianhydride, 4,4′-bis(2,3-dicarboxyphenoxy)diphenyl ether dianhydride, 4,4′-bis(2,3-dicarboxyphenoxy)diphenyl sulfide dianhydride, 4,4′-bis(2,3-dicarboxyphenoxy)benzophenone dianhydride, 4,4′-bis(2,3-dicarboxyphenoxy)diphenylsulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenyl ether dianhydride, 4-(2,3-dicarboxyphenoxy)-4′-(3,4-dicarboxyphenoxy)diphenyl sulfide dianhydride, 4-(2,3-dicarboxyphenoxy)-4′-(3,4-dicarboxyphenoxy)benzophenone dianhydride, or 4-(2,3-dicarboxyphenoxy)-4′-(3,4-dicarboxyphenoxy)diphenylsulfone dianhydride may be mentioned.

As the alicyclic diacid anhydride, for example, there may be mentioned monocyclic aliphatic diacid anhydrides such as cyclobutanetetracarboxylic type diacid anhydrides, or polycyclic aliphatic diacid anhydrides (formula 9).

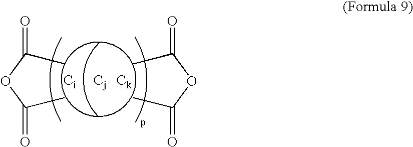

The repeating unit having a cyclic aliphatic structure of the polycyclic aliphatic diacid anhydride (formula 9) is a cyclic structure in which two carbon atoms are bridged by Ci or Ck, which represent two identical or different alkylene groups or alkenylene groups having 2 to 7 carbon atoms; and Cj, which represents a bond, an alkylene group or alkenylene group having 0 to 2 carbon atoms (for example, a single bond, a double bond, a methylene group, an ethylene group, an ethenylene group) as bridging groups. Specific examples of the polycyclic aliphatic diacid anhydride (formula 9) include bicyclo[2.2.2]oct-7-ene-2,3,5,6-tetracarboxylic dianhydride, or pentacyclo[8.2.1.1^{4,7}.0^{2,9}.0^{3,8}]tetradecane-5,6,11,12-tetracarboxylic acid dianhydride.

For example, an alicyclic poly(amic acid) (formula 10) can be synthesized from a polycyclic aliphatic diacid anhydride (formula 9), and an aliphatic diamine or alicyclic diamine (formula 2) by the production method of the invention, and when the alicyclic poly(amic acid) (formula 10) is cyclized and imidated, an alicyclic polyimide (formula 11) can be synthesized.

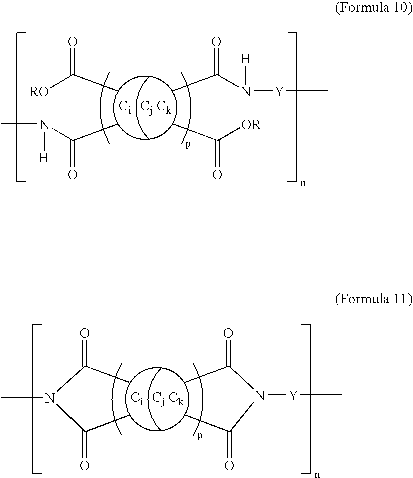

In the above formulae, Y is a cyclic aliphatic group, R is hydrogen atom or an acrylate group, Ci and Ck are each independently a substituted alkylene group or alkenylene group having 2 to 7 carbon atoms, Cj is a bond, an alkylene group or alkenylene group having 0 to 2 carbon atoms (for example, a single bond, a double bond, a methylene group, an ethylene group, an ethenylene group), p is an integer from 1 to 8, and n is an integer of 1 or greater.

As the alicyclic diacid anhydride, spiro-diacid anhydrides (formula 12) may be further mentioned.

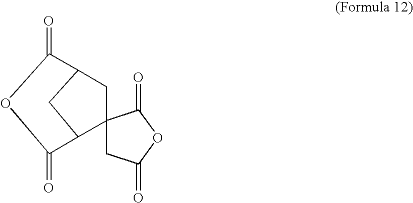

Spiro-diacid anhydrides (formula 12) include [1SR,5RS,6SR]-3-oxabicyclo[3.2.1]octane-2,4-dione-6-spiro-3′-(tetrahydrofuran-2′,5′-dione), [1S,5R,6S]-3-oxabicyclo[3.2.1]octane-2,4-dione-6-spiro-3′-tetrahydrofuran-2′,5′-dione, and [1R,5S,6R]-3-oxabicyclo[3.2.1]octane-2,4-dione-6-spiro-3′-tetrahydrofuran-2′,5′-dione. These compounds may have optical activity.

The diamine compound used in the invention is an aliphatic diamine or an alicyclic diamine (formula 2). Although the diamine compound is an aliphatic diamine or alicyclic diamine having a pKa of 10 to 11, since the compound is reacted with a weak acid having a pKa of 3 to 5, even if a salt is formed, the salt maintains a nucleophilicity equivalent to that of an aromatic amine, and can be dissolved in a solvent. Therefore, the diamine compound can be suitably copolymerized with an aromatic diacid anhydride or an alicyclic diacid anhydride.

H₂N—Y—NH₂ (Formula 2)

As the aliphatic diamine, for example, there may be mentioned ethylenediamine, propylenediamine, trimethylenediamine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, or bis(3-aminopropyl)sulfide.

For the alicyclic diamine (formula 2), Y is a cyclic aliphatic group, and for example, there may be mentioned a cycloalkylene group having 3 to 8 carbon atoms, a cycloalkenylene group having 3 to 8 carbon atoms, a cycloalkynylene group having 3 to 8 carbon atoms, a norbornenylene group, a decalinylene group, an adamantanylene group, or a cubanylene group.

As the alicyclic diamine, for example, there may be mentioned diaminocycloalkane, diaminocycloalkene, diaminocycloalkyne, diaminonorbornene, diaminodecaline, diaminoadamantane, or diaminocubane, and specific examples include 1,4-cyclohexanediamine, bis-(4-aminocyclohexyl)methane, or 1,3-diaminoadamantane.

It is preferable that the aliphatic diamine or alicyclic diamine be subjected to an acid having a pKa of 3 to 5, and then the resultant be reacted with an aromatic diacid anhydride or alicyclic diacid anhydride. The aliphatic diamine or alicyclic diamine is strongly basic, with the pKa being from 10 to 11, but when the diamine is reacted with an acid having a pKa of 3 to 5 to form a salt, the diamine attains nucleophilicity that is equivalent to that of an aromatic amine. Thus, the diamine can be favorably subjected to a copolymerization reaction with an aromatic diacid anhydride or alicyclic diacid anhydride.

As the acid having a pKa of 3 to 5 which is used in the production method of the present invention, organic acids or inorganic acids may be mentioned, and the organic acids may be exemplified by formic acid (pKa=3.6), acetic acid (pKa=4.7), propionic acid (pKa=4.9), or butyric acid (pKa=4.8), while the inorganic acids may be exemplified by phosphoric acid (pKa=4.2), or carbonic acid (pKa=4.9). The acid having a pKa of 3 to 5 which is used in the production method of the invention, is preferably an organic acid.

The acid having a pKa of 3 to 5 which is used in the production method of the present invention is preferably an acid having a low molecular weight, so that the acid can be volatilized and removed by heating at the time of imidation reaction.

The method of preparing a polyimide of the present invention includes a step of imidating the poly(amic acid) obtained by the method of preparing a poly(amic acid) of the present invention. As for the conditions for the imidation reaction of the poly(amic acid), for example, the reaction can be performed by heating at 260° C. to 400° C. under reduced pressure.

### Example 1

A poly(amic acid) was synthesized by the following techniques, using a mixture of 3,3′,4,4′-biphenyltetracarboxylic acid dianhydride (BPDA), 1,2-cyclohexanediamine (CHDA) and acetic acid.

(1) 3 mmol of 1,2-cyclohexanediamine (CHDA) were added to a pear-shaped flask, and a stirrer tip was introduced therein. Furthermore, the pear-shaped flask was attached with a reflux tube, and immersed in an oil bath. Because the compound easily absorbed the moisture in air, the operation was carried out quickly. At this time, the temperature of the oil bath was still room temperature.

(2) A three-way cock is attached to the top of the reflux tube, and the flask is purged with nitrogen. After the nitrogen purging, the flask is maintained with a nitrogen flow throughout the process.

(3) About 8 ml of dimethylacetamide (DMAC) was added through the top of the three-way cock. After the addition, the system was sufficiently stirred.

(4) The oil bath was heated to 90° C. to sufficiently dissolve CHDA in DMAC.

(5) When all of CHDA dissolved in DMAC, the system was removed from the oil bath, and was cooled to room temperature.

(6) To CHDA+DMAC cooled to room temperature, 6 mmol of acetic acid were added. When the mixture was sufficiently stirred, an acetic acid salt of CHDA was produced as a white precipitate.

(7) After the stirring, 3 mmol of 3,3′,4,4′-biphenyltetracarboxylic acid dianhydride (BPDA) were added thereto, and the mixture was stirred. At that time, since reaction heat would be generated, the flask was kept water-cooled (particularly intense cooling, for example, cooling with ice water, is unnecessary).

(8) In two hours of reaction time, the solution became transparent, with the viscosity increasing, and the proceeding state of the copolymerization reaction was monitored.

Production of poly(amic acid) was confirmed by IR measurement. The inherent viscosity of a DMAC solution of the resulting poly(amic acid) was measured, and was found to be 2.29 dl/g.

A DMAC solution of the obtained poly(amic acid) was cast and heated at 300° C., to obtain an insoluble film. Generation of polyimide was confirmed by IR measurement.

A polyimide film having a thickness of 25 μm was produced, and this was used as the Example.

### Comparative Example 1

(1) In the same manner as Example 1, 3 mmol of 1,2-cyclohexanediamine (CHDA) was dissolved in about 8 ml of dimethylacetamide (DMAC).

(2) To CHDA+DMAC cooled to room temperature, which was kept water-cooled, 3 mmol of 3,3′,4,4′-biphenyl tetracarboxylic acid dianhydride (BPDA) were added, and the mixture was stirred.

(3) After stirring for 24 hours, increase of viscosity was not observed.

### Example 2

In Example 1, a poly(amic acid) was obtained in the same manner as in Example 1 except that the addition amount of an acetic acid was changed to 12 mmol. The inherent viscosity of a DMAC solution of the resulting poly(amic acid) was measured, and was found to be 1.99 dl/g.

A DMAC solution of the obtained poly(amic acid) was cast and heated at 300° C., to obtain an insoluble film. Generation of polyimide was confirmed by IR measurement.

### Example 3

In Example 1, a poly(amic acid) was obtained in the same manner as in Example 1 except that the addition amount of an acetic acid was changed to 12 mmol, and reaction time was one hour. The inherent viscosity of a DMAC solution of the resulting poly(amic acid) was measured, and was found to be 1.83 dl/g.

A DMAC solution of the obtained poly(amic acid) was cast and heated at 300° C., to obtain an insoluble film. Generation of polyimide was confirmed by IR measurement.

### Example 4

In Example 1, a poly(amic acid) was obtained in the same manner as in Example 1 except that the addition amount of an acetic acid was changed to 12 mmol (reproduction check for Example 2). The inherent viscosity of a DMAC solution of the resulting poly(amic acid) was measured, and was found to be 2.54 dl/g.

A DMAC solution of the obtained poly(amic acid) was cast and heated at 300° C., to obtain an insoluble film. Generation of polyimide was confirmed by IR measurement.

### Example 5

In Example 1, a poly(amic acid) was obtained in the same manner as in Example 1 except that the addition amount of an acetic acid was changed to 12 mmol, and reaction time was four hours. The inherent viscosity of a DMAC solution of the resulting poly(amic acid) was measured, and was found to be 1.78 dl/g.

A DMAC solution of the obtained poly(amic acid) was cast and heated at 300° C., to obtain an insoluble film. Generation of polyimide was confirmed by IR measurement.

### Example 6

In Example 1, a poly(amic acid) was obtained in the same manner as in Example 1 except that the addition amount of an acetic acid was changed to 24 mmol. The inherent viscosity of a DMAC solution of the resulting poly(amic acid) was measured, and was found to be 1.28 dl/g.

A DMAC solution of the obtained poly(amic acid) was cast and heated at 300° C., to obtain an insoluble film. Generation of polyimide was confirmed by IR measurement.

### Example 7

In Example 1, a poly(amic acid) was obtained in the same manner as in Example 1 except that the addition amount of an acetic acid was changed to 6 mmol (reproduction check for Example 1). The inherent viscosity of a DMAC solution of the resulting poly(amic acid) was measured, and was found to be 1.77 dl/g.

A DMAC solution of the obtained poly(amic acid) was cast and heated at 300° C., to obtain an insoluble film. Generation of polyimide was confirmed by IR measurement.

### Example 8

In Example 1, a poly(amic acid) was obtained in the same manner as in Example 1 except that the addition amounts of all of agents were doubled. The inherent viscosity of a DMAC solution of the resulting poly(amic acid) was measured, and was found to be 1.63 dl/g.

A DMAC solution of the obtained poly(amic acid) was cast and heated at 300° C., to obtain an insoluble film. Generation of polyimide was confirmed by IR measurement.

What is claimed is:

1. A method of preparing a poly(amic acid), comprising a step of reacting an aromatic diacid anhydride or alicyclic diacid anhydride, an aliphatic diamine or alicyclic diamine, and an acid having a pKa of 3 to 5.

2. The method of preparing a poly(amic acid) according to claim 1, comprising in this order the steps of:
(i) reacting an aliphatic diamine or an alicyclic diamine with an acid having a pKa of 3 to 5, and then
(ii) reacting the resultant product with an aromatic diacid anhydride or alicyclic diacid anhydride.

3. The method of preparing a poly(amic acid) according to claim 1, wherein the acid having a pKa of 3 to 5 is an acid having a low molecular weight.

4. The method of preparing a poly(amic acid) according to claim 1, wherein the acid having a pKa of 3 to 5 is an organic acid.

5. The method of preparing a poly(amic acid) according to claim 4, wherein the organic acid is selected from the group consisting of formic acid, acetic acid, propionic acid, and butyric acid.

6. A method of preparing a polyimide, comprising a step of imidating a poly(amic acid) obtained by the method according to claim 1.
